(19) United States
(12) Patent Application Publication
(10) Pub. No.: US 2023/0351156 A1
(43) Pub. Date: Nov. 2, 2023

(54) METHOD AND SYSTEM FOR ADAPTING A NEURAL NETWORK USED IN A TELECOMMUNICATION NETWORK

(71) Applicant: Orange, Issy-les-Moulineaux (FR)

(72) Inventors: Quentin Lampin, CHÂTILLON CEDEX (FR); Louis Adrien Dufrene, CHÂTILLON CEDEX (FR); Guillaume Larue, CHÂTILLON CEDEX (FR)

(21) Appl. No.: 18/002,094

(22) PCT Filed: Jun. 3, 2021
(86) PCT No.: PCT/FR2021/051004

§ 371 Date: Dec. 16, 2022

(30) Foreign Application Priority Data
Jun. 17, 2020 (FR) FR2006325

(51) Int. Cl. G06N 3/045; G06N 3/084; H04B 17/391

(52) U.S. Cl. CPC G06N 3/045; G06N 3/084; H04B 17/3913

(57) ABSTRACT

In a communication network, an item of equipment uses a first neural network to implement a signal processing function, in order to process an input signal to obtain an output signal. A third neural network configured to determine a transfer function for transferring the parameters of a second neural network to the parameters of the first neural network is trained, the second neural network being less complex than the first network and also being used to implement the processing function, the first and second neural networks having been trained by the same input and output signals. The transfer function allows the parameters of the first network to be deduced from parameters of the second neural network. After detection of a change in the processing function, the parameters of the second network are adapted by means of input signals associated with a training sequence, and the parameters of the first neural network are adapted by using the adapted parameters of the second network and the transfer function.

### PRIOR ART

The invention relates to the general field of telecommunications. More specifically, the invention relates to the field of signal processing using neural networks called artificial neural networks in telecommunications networks.

FIG. 1 represents a communication network of the state of the art, for example a cellular communication network, in which a neural network NR can be implemented. The network includes at least one mobile terminal equipment UE, connected via a radio communication channel CN to a base station-type equipment BS. Assuming that the terminal UE emits a radio signal x(t) to the base station BS, the base station BS will receive a radio signal y(t) different from the emitted signal x(t). Indeed, the emitted signal x(t) undergoes alterations due to its propagation on the radio channel CN.

To overcome the effects of the channel CN, the base station implements a network function in the form of a neural network NR to estimate, from the received signal y(t), the signal x(t) emitted by the terminal UE. To this end, the radio channel CN is modeled by choosing the functions of the different neurons, and by training the neural network NR so that it determines the parameters (weight P and bias) of each neuron during a phase of learning the network NR. For example, during this phase, the neural network NR receives a plurality of signals y′(t) corresponding respectively to emitted signals x′(t) belonging to a set of known sequences. Once the learning phase is complete, the neural network is capable of estimating an emitted signal x(t) for a new received signal y(t).

A problem arises if the radio channel CN evolves over time, for example due to the movement of the terminal UE, to the climatic conditions, to the appearance or disappearance of obstacles in the transmission of signals on the channel CN, to an evolution of a number of terminals connected to the base station BS, to an evolution of interferences of other channels with the channel CN, etc. When the radio channel CN evolves, it is necessary to adapt (relearn) the neural network NR to take into account the evolution of the channel CN and improve the estimate of the signal x(t).

The adaptation of the neural network requires time and resources in terms of memory and computing capacity. The adaptation is all the more long and costly as the neural network model is complex.

It is noted that in a telecommunications network, the network function that performs the adaptation of a neural network transmits the parameters of this neural network to other network functions that use the neural network. In the example illustrated in FIG. 1, following the adaptation of the neural network NR implemented by the base station BS, the station BS sends the new parameters (functions, weights and bias) of its network NR to other network equipment, for example to the terminal UE. In another illustrative example, the terminal UE uses the new parameters to initialize its own neural network.

When the network function is shifted, it is necessary to transfer the data necessary for the learning, which requires significant network resources.

A solution can consist in using a neural network with a less complex architecture, so that its adaptation is faster, easier and less expensive, but such a network presents a weaker expressivity. A complexity of a neural network is for example defined in terms of number of parameters, number of neurons, number of layers. It is recalled that the expressivity of the neural network NR represents its ability to approximate the implemented signal processing function, for example the equalization function. The latter allows correcting the received signal to facilitate its demodulation. This modification is made according to the channel CN. A weaker expressivity therefore affects the reliability of the estimate of the emitted signal x(t).

Another solution can consist in taking into account, during the adaptation, only some parameters, for example the weights of a limited number of neurons, by freezing the weights associated with other neurons. This solution is not satisfactory because it requires knowing the weights to be freezed. The equalization applied to the received signal to estimate the emitted signal x(t) is thus less reliable.

There is therefore a need for a solution that allows reducing the network resources necessary to adapt to the evolutions of the equalization function implemented with a neural network, more generally to evolutions of a signal processing function, and which does not have the drawbacks of the methods of the state of the art.

### DISCLOSURE OF THE INVENTION

The invention relates to a method for adapting the parameters of a first neural network used in a communication network to implement a signal processing function by an equipment, to process an input signal in order to obtain an output signal. The method includes steps of:
learning a third neural network configured to determine a function of transfer from the parameters of a second neural network to the parameters of the first neural network, the second neural network being less complex than the first neural network and also being used to implement the signal processing function, the learnings of the first and second neural networks having been performed by the same input and output signals, the transfer function making it possible to deduce parameters of the first network from parameters of the second neural network;
following a detection of an evolution of said processing function, adaptating the parameters of the second neural network by means of input signals associated with a learning sequence; and
adaptating the parameters of the first neural network by using the adapted parameters of the second network and the transfer function.

Correlatively, the invention relates to a system for adapting the parameters of a first neural network used in a communication network to implement a signal processing function by an equipment to process an input signal in order to obtain an output signal, the system including:
a device, called “third device”, configured to perform a learning of a third neural network configured to determine a function of transfer from the parameters of a second neural network to the parameters of the first neural network, the second network being less complex than the first network and also being used to implement the signal processing function, the learnings of the first and second neural networks having been performed by the same input and output signals, the transfer function making it possible to deduce parameters of the first network from parameters of the second neural network;
a device, called “second device”, configured to adapt, following a detection of an evolution of said processing function, the parameters of the second neural network by means of input signals associated with a learning sequence; and
a device, called “first device”, configured to adapt parameters of the first neural network by using the adapted parameters of the second network and the transfer function.

The adaptation system in accordance with the invention implements the adaptation method in accordance with the invention.

The characteristics and advantages of the proposed adaptation method presented below apply in the same way to the proposed adaptation system and vice versa.

In accordance with the invention, the architecture of the first neural network is more complex than that of the second neural network. The time required for the learning of the first network is greater than the time required for the learning of the second network. However, the expressivity of the first network is better than that of the second network.

In this document, “complex” network designates the first network, and “simple” network designates the second neural network.

In accordance with the invention, the first and second neural networks are configured to perform the same signal processing function. For example, this signal processing function corresponds to the estimate of the signal emitted by an emitting equipment on a communication channel to a receiving equipment. The input signal corresponds to the signal received by the receiving equipment and the output signal then corresponds to the estimate of the emitted signal. In this example, the first and second neural networks model the equalization function of the communication channel, the modeling by the first neural network being more reliable. The second neural network can be considered as an approximation of the first neural network.

The first neural network (called complex) is configured with more parameters than the second neural network (called simple) thus allowing it to carry out more complex signal processing operations to implement the signal processing function. In the example of the equalization method, this comes in particular to compensate for the complex non-linearity effects of the power amplifiers or the effects related to its propagation on the channel, such as power attenuation, a phase rotation, a masking and a frequency or time offset.

According to the invention, during an initial learning, the two simple and complex neural networks are trained with the same input signals (for example the signals received by the receiving equipment) and the same target signals (for example the signals emitted by the emitting equipment).

The transfer function according to the invention allows determining the parameters of the complex network from the parameters of the simple network. The adaptation of the complex network is based on this transfer function to deduce, from the adapted parameters of the simple network, the new parameters of the complex network.

The transfer function according to the invention is an application from a set of real numbers of dimension n, Rn, to a set of real numbers of dimension m, Rm, where n and m are strictly positive integers, and m is greater than n. The transfer function is a signal processing function, for example an arithmetic function. The third neural network for implementing the transfer function is trained with parameters of the second neural network as inputs. The target of the third neural network is to determine the set of the parameters of the first neural network as if the former had been trained directly from signals transmitted over the communication channel. The third neural network learns how to obtain the complex network from the simple network.

The proposed technique allows reducing the time, the memory and the computing capacity required for the adaptation of the complex neural network. Indeed, the adaptation of the parameters of the complex network uses only the parameters of the simple neural network and the transfer function performed by the third neural network as defined previously. The adaptation of the complex neural network is thus faster.

The proposed technique also allows reducing the consumption of resources necessary for the device implementing the first neural network by making it possible to shift the adaptation of this first network to another device, without requiring the transmission of the data necessary for this adaptation.

Following a change in the operating conditions of the system, for example the evolution of the communication channel, it may be necessary to adapt the parameters of the simple neural network. The adaptation of the parameters of the complex neural network can be performed less frequently than the adaptation of those of the simple neural network, for example after five adaptations of the simple neural network.

In one embodiment, the first device that performs the adaptation of the parameters of the complex neural network has more resources in terms of memory and computing capacity than the second device that performs the adaptation of the parameters of the simple neural network. In one embodiment, the first (or respectively the second) device also performs the initial learning of the first (or respectively the second) neural network.

In another embodiment, the adaptation of the parameters of the first neural network, the adaptation of the parameters of the second neural network, and/or the determination of the transfer function can be performed by the same device.

In one particular embodiment, the proposed method further includes, after the adaptation of the parameters of the second neural network according to the input signals associated with the learning sequence and the adaptation of the parameters of the first neural network by using the adapted parameters of the second network and the transfer function, following the detection of the evolution of the processing function, a step of complementarily adapting the adapted parameters of the first network according to the input signals associated with this learning sequence. This particular embodiment allows further improving the performances of the first network even after the adaptation of its parameters.

As proposed, the execution of a said neural network can be performed by a device other than the one that performs the learning and/or the adaptation of the parameters of this neural network. The device performing the learning or the adaptation sends the parameters of the neural network to the device executing it.

The invention has an advantageous application within the context of the standardization of the nature of the exchanges between the equipment of a communication network for the implementation of the neural networks.

In one embodiment of the invention, the second device is a base station, for example an eNodeB, evolved eNodeB or gNodeB-type base station and the first device is a server of the core of the communication network, for example a datacenter-type server. The third device is a server of the communication network, which can be in particular the same as the first device.

The invention also relates to a computer program on a recording medium, this program being capable of being implemented in a computer or one of the devices of the proposed adaptation system. This program includes instructions adapted to the implementation of an adaptation method as described above, when the program is executed by a computer.

The program can use any programming language, and be in the form of source code, object code, or intermediate code between source code and object code, such as in a partially compiled form, or in any other desirable form.

The invention also relates to computer-readable information medium or recording medium, and including instructions of the computer program as mentioned above.

The information or recording medium can be any entity or device capable of storing the program. For example, the medium can include a storage medium, such as a ROM, for example a CD ROM or a microelectronic circuit ROM, or a magnetic recording means, for example a floppy disk or a hard disk or a flash memory.

On the other hand, the information or recording medium can be a transmissible medium such as an electrical or optical signal, which can be routed via an electrical or optical cable, by radio link, by wireless optical link or by other means.

The program according to the invention can be particularly downloaded from an Internet-type network.

Alternatively, the information or recording medium can be an integrated circuit in which the program is incorporated, the circuit being adapted to execute or to be used in the execution of the method in accordance with the invention.

### BRIEF DESCRIPTION OF THE DRAWINGS

Other characteristics and advantages of the present invention will become apparent from the description given below, with reference to the appended drawings which illustrate one exemplary embodiment without any limitation. On the figures:

FIG. 1, already described, illustrates an architecture of a communication network in which a neural network is used according to one method of the state of the art;

FIG. 2 is an architecture of a communication network NET in which a method for adapting the parameters of a neural network is implemented according to one particular embodiment;

FIG. 3 is a flowchart representing the steps of an adaptation method implemented according to one particular embodiment;

FIG. 4 represents a functional architecture, according to one particular embodiment, of a system for adapting the parameters of a neural network; and

FIG. 5 presents a hardware architecture of a device of the adaptation system according to one particular embodiment.

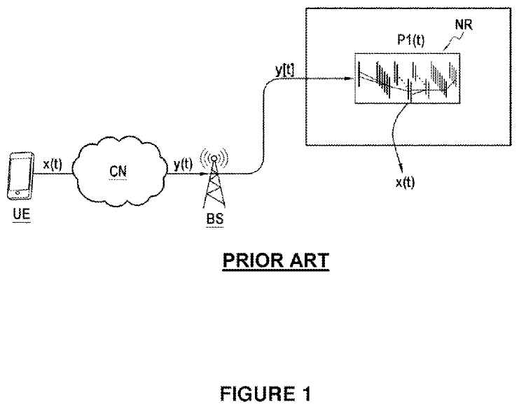

### DESCRIPTION OF THE EMBODIMENTS

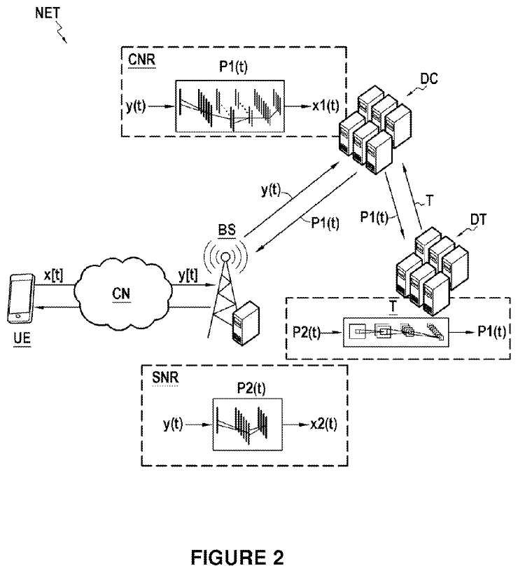

FIG. 2 is an architecture of a communication network NET in which a method for adapting the parameters of a neural network is implemented according to one particular embodiment.

In the embodiment described here, the network NET is a cellular communication network, for example of the 3G, 4G or 5G type. However, the proposed method can be implemented in communication networks based on other technologies. For example, the communication network NET is an optical network.

The communication network NET includes at least one terminal UE of a user such as a mobile telephone and at least one eNodeB or gNodeB-type base station BS. A radio communication channel CN connects the terminal UE to the base station BS. The network NET also includes two datacenter-type servers DC and DT. The base station BS and the servers DC and DT form an adaptation system SYS in accordance with the invention.

A radio signal x(t) emitted by the terminal UE to the base station BS undergoes alterations of the channel CN, for example complex non-linearity effects of the power amplifiers or effects related to its propagation on the channel, such as an attenuation of its amplitude (power), a masking, a rotation of a phase of the symbols comprised in the signal, a frequency offset, a sampling desynchronization, an interference with other transmitted signals on neighboring channels, etc. The base station receives a signal y(t) different from the emitted signal x(t).

The base station BS has the architecture of a computer. It is configured to implement an SNR neural network. The base station BS is configured to perform the phase of learning the SNR network, to adapt the parameters P2(t) of this SNR network and also to execute it (inference phase) once the learning (or adaptation) phase is complete. This SNR neural network allows executing a signal processing function, such as an equalization function to overcome the effects of the channel CN. The base station BS is also configured to execute a CNR neural network of higher complexity than that of the SNR network.

The server DC is configured to perform the learning of this complex CNR neural network. This CNR neural network allows executing a signal processing function, such as an equalization function to overcome the effects of the channel CN.

The SNR and CNR networks are both intended to estimate the signal x(t) emitted by the terminal UE from the signal y(t) received by the base station BS (also called input signal). Both SNR and CNR networks carry out signal processing operations to implement the equalization function. The expressivity of the complex CNR network is better than that of the simple SNR network. The two SNR and CNR networks are trained by the same set of input y(t) and output x(t) signals. In one particular embodiment, the two networks use an identical error function.

The result of the estimate of the signal x(t) by application of the simple SNR network is denoted x2(t). The result of the estimate of the signal x(t) by application of the complex CNR network is denoted x1(t). The parameters of the SNR and CNR networks are denoted respectively P2(t) and P1(t), these parameters being the functions, the weights and the biases of the neurons of each of these networks.

The server DT is configured to perform the learning of a third neural network T which is configured to determine a function of transfer from the parameters P2(t) of the simple SNR network to the parameters P1(t) of the complex CNR network. The transfer function of the network T allows deducing the parameters P1(t) of the complex CNR network from the parameters P2(t) of the simple SNR network.

The server DT sends to the server DC the network T implementing the transfer function. When the channel CN evolves, the base station BS performs an adaptation of the simple SNR network and sends the new parameters P2(t) of the SNR network to the server DC. For the adaptation of the complex CNR network, the server DC uses the network T and the adapted parameters P2(t) to determine the new parameters P1(t) of the complex CNR network and to adapt them.

The base stations BS, the servers DT and DC are described as devices. Their network function can also be implemented by virtual functions (VNF for “Virtual Network Function”) executed on equipment.

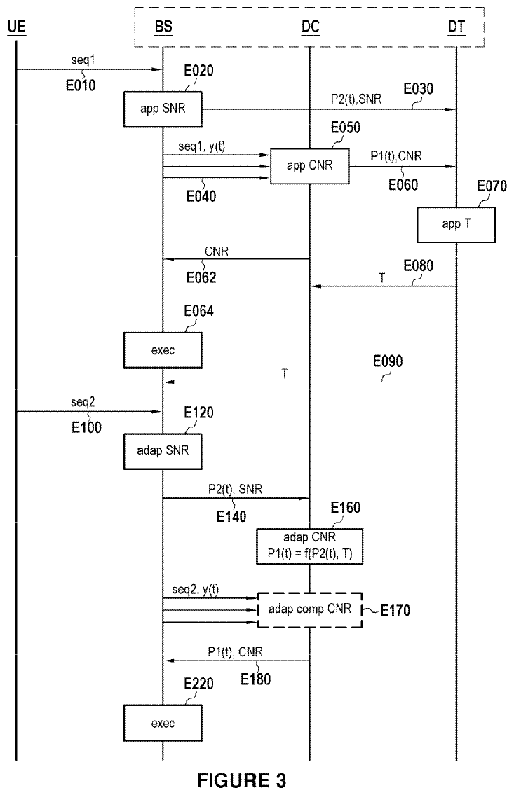

FIG. 3 is a flowchart representing the steps of an adaptation method, implemented according to one particular embodiment, by the system SYS described with reference to FIG. 2.

During a step E010, the terminal UE, as emitter, transmits a learning sequence seq1 including symbols allowing the base station BS, as receiver, to estimate the communication channel CN. This learning sequence seq1 can be entirely or partially known by the receiving device, as well as its statistical properties. This emitted sequence seq1 includes all the target signals x(t) for the receiving device BS. By way of illustration, a sequence of deterministic symbols is of the Zadoff-Chu type. One example of such a sequence is defined in the 3GPP TS 38.211 specification “NR; Physical channels and modulation (Release 15)” v15.8.0.

During a step E020, the base station BS learns the parameters P2(t) of the simple SNR network. The terminal UE sends target signals x(t), corresponding to the learning sequence seq1, and the base station BS receives signals y(t), called input signals, which correspond to the signals x(t) following their alteration through the channel CN. For example, this learning E020 iteratively updates the parameters of the simple SNR network by back-propagation of the gradient by minimizing a cost function (also called error function) based on the quality of the reconstruction by the model of the known sequence seq1. At the end of the learning phase E020, and during a step E030, the base station BS sends the parameters P2(t) to the server DT.

During a step E040, the base station BS sends the learning sequence seq1 and the signals y(t) associated with this learning sequence it has received to the server DC. In one particular embodiment, the base station BS only sends the signals y(t) associated with this learning sequence it has received to the server DC. In this particular embodiment, the server DC has information relating to the learning sequence, for example a learning sequence number, or memorizes the learning sequence.

During a step E050, the server DC learns the parameters P1(t) of the complex CNR network. For example, this learning E050 iteratively updates the parameters of the complex network by back-propagation of the gradient by minimizing the cost function based on the quality of the reconstruction by the model of the known sequence seq1. At the end of the learning phase E050, and during a step E060, the server DC sends the parameters P1(t) to the server DT.

In the mode described here, the server DC sends during a step E062 to the base station BS the parameters P1(t) of the complex CNR network learned. The base station BS is able to execute the complex CNR network, but not able to perform its learning. The base station BS is able to execute the simple SNR network.

During a step E064, the base station BS estimates a signal x(t) having been emitted by the terminal UE from an input signal, the received signal y(t) coming from the terminal. The base station uses the complex CNR network for the estimate E064 because its expressivity is greater. When it does not have the resources necessary for the execution of complex CNR network, it uses the simple SNR network. The estimated signal is denoted x1(t) or x2(t) according respectively to the CNR or SNR neural network used for the estimate.

During a step E070 which can be implemented in parallel, before or after steps E062 and E064, the server DT executes a phase of learning the parameters of the neural network T, which implements the transfer function. This transfer function allows determining the parameters P1(t) from the parameters P2(t). The server DT received the parameters P1(t) and P2(t) during steps E060 and E030 respectively.

At the end of the phase of learning E070 the neural network T, and during a step E080, the server DT sends to the server DC the parameters of the trained network T.

In one particular embodiment, for example within the context of a subsequent transmission, the terminal UE transmits, during a step E100, target signals x(t) corresponding to another known learning sequence seq2, to the base station BS, for example a Zadoff-Chu type sequence.

The base station BS receives signals y(t) that correspond to the signals x(t) of this other learning sequence seq2 following their alteration by the channel CN. The base station BS then detects an evolution of the channel CN, for example, by a performance drop observed after an inference by the simple SNR network. During a step E120, the base station BS adapts the previous parameters P2(t) of the simple SNR network from the signals y(t) associated with this other learning sequence seq2 it has received. It is emphasized here that the learning sequences seq1 and seq2 can be identical.

During a step E140, the base station BS sends the adapted parameters P2(t) of the simple SNR network to the server DC.

During a step E160, the server DC adapts the complex CNR network by using the transfer function of the network T and the adapted parameters P2(t) of the simple SNR network. By executing the network T with the adapted parameters P2(t) as input, the server DC determines the adapted parameters P1(t) of the complex CNR network.

During a step E180, the server DC sends the adapted parameters P1(t) of the complex CNR network to the base station BS.

During a step E220, the base station BS preferably executes the complex CNR network to implement the function of equalization of the radio channel CN and estimate the signals x(t) that have been emitted by the terminal EU. If the resources of the base station BS do not allow it to execute the complex CNR network (limited memory or computing capacity), it uses during the step E200 the simple SNR network to implement the equalization function.

According to one example, if the alteration of the signal x(t) by the channel CN results in an attenuation of its power by half, the CNR or SNR neural network implements a function of equalization of the received signal y(t) by multiplying its power by two to estimate the signal x(t). The CNR neural network can compensate for other more complex effects and implement the equalization function with better reliability.

In one embodiment, the parameters P2(t) of the simple SNR network are adapted (E120) following each detection (E100) of an evolution of the equalization function. The parameters P1(t) of the complex CNR network can be adapted (E160) less often, for example every five or ten adaptations of the parameters P2(t) of the simple SNR network.

In one embodiment, the parameters P1(t) of the complex CNR network are adapted (E160) if it is determined that the difference between the results of the two SNR and CNR networks exceeds a certain threshold. Particularly, the difference can be observed by the base station BS, which sends, if the difference exceeds the threshold, a request to the server DC to adapt the parameters P1(t) of the complex CNR network.

In another embodiment, the base station BS is able to adapt the complex CNR network. During a step E090 presented in dotted lines in FIG. 3, the server DT sends the network T to the base station BS. Following the adaptation E120 of the simple SNR network, the base station can locally adapt the complex CNR network by using the network T and the new parameters P2(t) of the simple SNR network. In other words, the base station BS implements the adaptation step E160 instead of the server DC, which avoids the exchanges E140 and E180 with the server DC.

In one embodiment, the base station BS is configured to execute the complex and simple neural networks but is not configured to train or adapt them. The proposed system SYS then includes another device configured to train and adapt the simple SNR network and transmit its parameters to the base station so that it can execute it.

In one particular embodiment, following the adaptation (E160) of the parameters P1(t) of the CNR network by using the adapted parameters P2(t) of the SNR network and the transfer function, the server DC uses during an optional step E170 (represented in dotted lines in FIG. 3) the input signals y(t) associated with the learning sequence seq2 for a complementary adaptation of the current parameters P1(t). In this particular embodiment, the base station BS transmits the learning sequence seq2 and the signals y(t) associated with the sequence seq2 it received and which have been used to adapt (E120) the SNR neural network. This embodiment allows optimizing the adapted parameters P1(t) of the complex CNR network. In one particular embodiment, the base station BS only sends the signals y(t) associated with this learning sequence it received to the server DC. In this particular embodiment, the server DC has information relating to the learning sequence, for example a learning sequence number, or memorizes the learning sequence.

The SNR and CNR neural networks are configured to implement an equalization function. In general, the SNR and CNR neural networks are configured to implement a signal processing function to process an input signal (y(t)) in order to obtain an output signal (x(t)). For example, the signal processing function can include time and/or frequency synchronization between the emitter and the receiver. To maintain this synchronization, it is necessary to perform a certain number of time/frequency drift measurements.

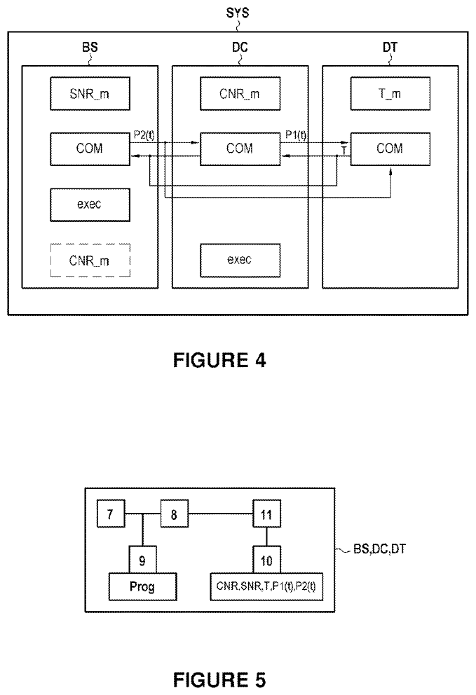

FIG. 4 represents a functional architecture, according to one embodiment of the invention, of the proposed adaptation system SYS, described with reference to FIGS. 2 and 3.

The system SYS includes the base station BS, the server DC and the server DT. These devices include respectively modules SNR_m, CNR_m and T_m which are configured to learn (E020, E050, E070) the SNR, CNR and T neural networks, and adapt their parameters (E120, E160, E170).

The base station BS includes a module exec configured to execute (E064, E220) the simple SNR network and/or the complex CNR network.

Each of the devices of the system SYS includes a communication module COM configured to exchange (E030, E060, E080, E090, E140 and E180) the neural networks as previously described with reference to FIG. 3.

In one embodiment, the base station BS further includes a module CNR_m configured to adapt the complex CNR network.

In one embodiment, the base station BS and the server DT form a single device.

In another embodiment, the servers DT and DC form a single device.

In the embodiment described here, each device BS, DC and DT of the adaptation system SYS has the hardware architecture of a computer, as represented in FIG. 5.

The architecture of each of the devices BS, DC and DT comprises in particular a processor 7, a random access memory 8, a read only memory 9, a non-volatile flash memory 10 in one particular embodiment, as well as communication means 11. Such means are known per se and are not described in more detail here.

The read only memory 9 of the device BS, DC, DT constitutes a recording medium in accordance with the invention, readable by the processor 7 and on which a computer program Prog in accordance with the invention is recorded here.

The memory 10 of the device BS, DC, DT allows recording variables used for the execution of the steps of the method for adapting a neural network as described previously, such as the CNR, SNR and T neural networks, and the parameters P1(t) and P2(t).

The computer program Prog defines functional and software modules here, configured to adapt the parameters of a neural network from a transfer function and parameters of another network of less complexity. These functional modules are based on and/or control the hardware elements 7-11 of the device BS, DC, DT DG mentioned above.

1. A method for adapting the parameters of a first neural network used in a communication network to implement a signal processing function by an equipment, to process an input signal in order to obtain an output signal, said method comprising:
learning a third neural network configured to determine a transfer function of transfer from the parameters of a second neural network to the parameters of said first neural network, the second network being less complex than said first network and also being used to implement said processing function, the learnings of the first and second neural networks having been performed by the same input and output signals, said transfer function making it possible to deduce parameters of said first network from parameters of said second network;
after detection of an evolution of said processing function, adapting the parameters of said second network by means of input signals associated with a learning sequence; and
adapting the parameters of said first neural network by using the adapted parameters of the second network and said transfer function.

2. The method of claim 1, wherein adapting the parameters of said first network is performed at a lower frequency than adapting the parameters of said second network.

3. The method of claim 1, further including complementarily adapting the adapted parameters of said first network according to the input signals associated with the learning sequence.

4. A non-transitory computer readable medium having stored thereon instructions which, when said method is executed by a computer processor, cause the processor to implement the method of claim 1.

5. A computer comprising a processor and a memory, the memory having stored thereon instructions which, when executed by the processor, cause the processor to implement the method of claim 1.

6. A system for adapting the parameters of a first neural network used in a communication network to implement a signal processing function by an equipment to process a input signal in order to obtain an output signal, said system including:
a third device, configured to perform a learning of a third neural network configured to determine a transfer function from the parameters of a second neural network to the parameters of said first neural network, the second network being less complex than said first network and also being used to implement said processing function, the leanings of the first and second neural networks having been performed by the same input and output signals, said transfer function making it possible to deduce parameters of said first network from parameters of said second network;
a second device, configured to adapt, after detection of an evolution of said processing function, the parameters of said second network by means of input signals associated with a learning sequence; and
a first device, configured to adapt parameters of said first network by using the adapted parameters of the second network and said transfer function.

7. The system of claim 6, wherein said second device is a base station and said first and third devices are servers of a core of said communication network.
